(19) United States
(12) Patent Application Publication
(10) Pub. No.: US 2024/0051503 A1
(43) Pub. Date: Feb. 15, 2024

(54) Travel Trailor with Jackless Tongue

(71) Applicants: Christopher J. Barth, Bristol, IN (US); Ben Kauffman, Goshen, IN (US); Thomas L. Fountain, Niddlebury, IN (US)

(72) Inventors: Christopher J. Barth, Bristol, IN (US); Ben Kauffman, Goshen, IN (US); Thomas L. Fountain, Niddlebury, IN (US)

(21) Appl. No.: 17/803,528

(22) Filed: Aug. 9, 2022

(51) Int. Cl. B60S 9/22; B60P 3/32; B60S 9/12; B60R 5/02; B60D 1/167

(52) U.S. Cl. CPC B60S 9/22; B60P 3/32; B60S 9/12; B60R 5/02; B60D 1/167; B60D 1/065

(57) ABSTRACT

A travel trailer is provided having no jack on hitch tongue, and fifth wheel-type landing gear mounted inside the front cap, for inclined extension toward the ground when used, and a more secure, twist-resistant mounting bracket for the jack tubes mounted within the front cap.

The present application is a continuation-in-part of U.S. patent application Ser. No. 29/742,060, filed on Oct. 30, 2019, and currently pending before the United States Patent and Trademark Office. The present invention relates to “recreational vehicles (“RVs”),” meaning vehicles, and particularly travel trailers, having a portable living quarters therein, and as defined by the Recreational Vehicle Industry Association.

### BACKGROUND OF THE INVENTION

RVs are typically versatile vehicles which maybe used for concurrently or separately hauling equipment, other vehicles, personal property, people, and animals. RVs are often used for camping and/or recreation, or as temporary living quarters for an extended period of time. Usually, an RV is constructed with an interior with living quarters having a variety of features therein, such as beds, kitchens, bathrooms, furniture, cabinets, tables. and counter tops. Storage areas are commonly formed within the living quarters which can be accessed from interior of the RV and/or from the exterior of the RV.

There are several different types of RVs, generally categorized as towable RVs and motorized RVs. Towable RVs include “fifth wheel trailers” and “travel trailers,” the former having a portion of the living quarters overhanging the towing hitch assembly, the latter having the towing hitch assembly extending in front of the living quarters for connection to the bumper hitch of the towing vehicle. This extending towing hitch assembly is generally a triangular or A-frame beam construction or “tongue” upon which propane fuel tanks, spare wheels, and a jack assembly have often previously been mounted. Travel trailers often have a front cap, usually molded from fiberglass of the like, which is mounted to the front of the living quarters and above the connection of the extending towing hitch assembly. These caps are often of a curved and/or incline configuration (especially from a side view) which can serve to decrease wind resistance of the vehicle when it is towed, as well as to increase the aesthetic appeal of the vehicle.

When towable RVs are in motion, they are usually supported by a wheel and suspension system toward the rear of the vehicle, and by the hitch connection to the towing vehicle. This support typically allows secure connection between the RV and the towing vehicle while allowing sufficient maneuverability for towing along roads and various other terrain. When stopped and disconnected from the towing vehicle, however, it is usually desirable to substantially reduce the motion of the RV, especially when occupied by users, so that it becomes a stable platform, often regardless of the motion which would be afforded by its wheels and suspension system. Also, it is often desirable to level the RV, regardless of the terrain it is parked upon. In addition, it is usually necessary to adjust the altitude and/or attitude of the RV hitch/receiver with respect to the receiver/hitch of the towing vehicle, at least temporarily, in order to disengage the towing vehicle. Further, with “toy hauler” travel trailers, it is has been found to be advantageous to facilitate the loading of the trailer via the rear ramp door by elevating the front of the trailer such that angle of the ramp with respect to the floor of the trailer garage becomes smaller or non-existent.

To accomplish these functions, various different mechanisms have been previously used. In fifth wheel trailers, long “landing gear” hydraulic systems are often used at the front of the trailer, mounted in or near the overhand of the living quarters. However, spacial constraints in travel trailers have often precluded such systems, and travel trailers instead typically used alone or in combination stabilizing jacks, leveling systems, wheel blocks, hitch tongue jacks (with or without caster wheels). However, it is important to maintain low costs of manufacture and maintenance in travel trailers, as well as to maximize ground clearance, these prior systems for making the travel trailer more liveable have often compromised those objectives. Further, in order to maximize the effectiveness of these prior systems in travel trailers, it can be important to place the ground-engaging elements at the physical extremities of the travel trailer ground profile. However, doing so in prior travel trailers can reduce the resistance of those systems to destructive twisting forces, adverse road conditions, weather, water migration, and the like, as well as to reduce vehicle ground clearance (in certain constructions), and other functional characteristics of the vehicle. Further still, it is important that operating systems of travel trailers be simplified and user friendly in order for them to be desirable and effectively implemented.

The front caps of travel trailers are typically formed with a small volume of space between the front of the trailer and the forward-most portion of the living quarters. On occasion, prior travel trailers have mounted equipment within the front caps, but the desirability of doing so has been limited by those spacial constraints, as well as the limited access for maintenance of that equipment, and the risk of weather, water, debris contamination/migration from apertures from the front cap for utilization of that equipment. In addition, in prior travel trailer structures, sufficient structural support behind the cap for secure mounting of equipment under the cap has been significantly limited. As a result, use of prior ground engaging structure in front caps would have been subject to destructive twisting and torque forces, and risked cracking or puncturing the front cap.

### OBJECTIVES OF THE INVENTION

Accordingly, a primary objective of the invention is to provide improved travel trailers and hitch/ground support arrangements therefor. These improvements include providing such travel trailers and/or arrangements which:
a. are inexpensive to manufacture, install, maintain, and repair,
b. increase floor plan optimization when used in a vehicle, such as an RV, for both living quarters and storage space,
c. minimize component weight,
d. increase storage area and accessibility thereto,
e. increase supplemental feature accessibility and user ease,
f. are more readily retro-fitted into pre-existing RVs, and
f. increase the aesthetic appeal of RVs.

### SUMMARY OF THE INVENTION

These and other objectives of the present invention are achieved by the provision of a travel trailer having no jack on hitch tongue, and fifth wheel-type landing gear mounted inside the front cap, for inclined extension toward the ground when used, and a more secure, twist-resistant mounting bracket for the jack tubes mounted within the front cap.

Other objects, advantages, and novel features of the present invention will become readily apparent from the following drawings and detailed description of certain preferred and alternative embodiments.

### Characterization of the Invention Aesthetics:

The present invention is characterized by having no jack on the tongue of the travel trailer, the “tongue” being an extension from the front of the travel trailer toward the rear of the towing vehicle, and which is connected to a hitch ball or hitch connection structure of the towing vehicle (such as a pick-up truck). In prior travel trailers, the tongue includes a jack adjacent its forward end, which is extendable downwardly to the ground in order to level and/or support the travel trailer when the tongue is disconnected from the towing vehicle and the travel trailer is in use. In these prior arrangements, the tongue is thereby elevated, rather than resting on the ground, when the travel trailer is not connected to the towing vehicle. The design of the present invention maintains such elevated tongue orientation, but avoids the use of such a jack, in preferred embodiments, by using fifth wheel landing gear mounted in the body of the travel trailer. Thus, an aesthetically pleasing, and uncluttered tongue appearance is provided when the travel trailer is in use while camping, for example, and/or elevated to a level position, with the tongue protruding in a cantilevered format from the travel trailer body without ground contact. This aesthetic appearance is independent of the specific types of beams and structure used to create the tongue, since it is the profile of the tongue itself which comprises the claimed design.

The specific travel trailer size and exterior shape, the specific types of beams and structure used to form the tongue, the functional components of the travel trailer, such as the hitch ball connection structure, and exterior propane takes typically mounted in the hitch are not part of the claimed design and are omitted for clarity from the drawing or shown in dashed lines in FIGS. 1-3.

### BRIEF DESCRIPTION OF THE DRAWINGS

FIG. 1 shows a left side view of a travel trailer incorporating the design of the present invention, the right side view being a mirror image thereof.

FIG. 2 shows a top view of a travel trailer having the tongue profile of FIG. 1 (although not to scale with FIG. 1), where the tongue structural elements create a V shape toward the hitch ball of a towing vehicle (that vehicle not being shown), and the hitch ball connection structure at the forward-most or free end of the tongue is shown in dashed lines. This embodiment should be considered as a species of the genus embodiment of FIG. 1. The bottom view would be a mirror image of the view of this figure.

FIG. 3 shows a front end view of the travel trailer of FIG. 1, the rear end view forming no portion of the claimed design.

FIG. 4 shows a left side view of a best mode embodiment of a travel trailer incorporating the design of the present invention. This embodiment should be considered as a species of the genus embodiment of FIG. 1.

FIG. 5 shows a left side, upper front perspective view of the embodiment of FIG. 4, looking to the rear of the travel trailer.

FIG. 6 shows a left side, upper front perspective view of a portion of a travel trailer of the type shown in FIG. 5 with the left side wall removed to show certain internal structure, and the front cap in place over the landing gear arrangement of the present invention, that landing gear being in a substantially retracted position.

FIG. 7 shows the view of FIG. 6 withe the front cap removed.

FIG. 8 shows an enlargement of the view of FIG. 7 with additional structure of the RV removed.

FIG. 9 shows a further enlargement of the view of FIG. 8 with additional structure of the RV removed and the bracket assembly in exploded position.

FIG. 10 shows a side view of a preferred embodiment of the present invention corresponding to the view of FIG. 6.

FIG. 11 shows an enlarged side view of a detail of the bracket assembly as indicated with respect to FIG. 10.

FIG. 12 shows a front view of the embodiment of FIG. 10 with the underlying structure illustrated by translucent (shaded) view of the front cap.

FIG. 13 shows a cross sectional view of the embodiment of FIG. 10, taken along lines AA in the direction of the arrows, with the cap access doors 34 in place on front wall 32.

FIG. 14 shows the view of FIG. 13 with the cap access doors 34 removed from front wall 32.

FIG. 15 shows an enlarged front, right upper perspective view of the Z plate components of bracket assembly 38.

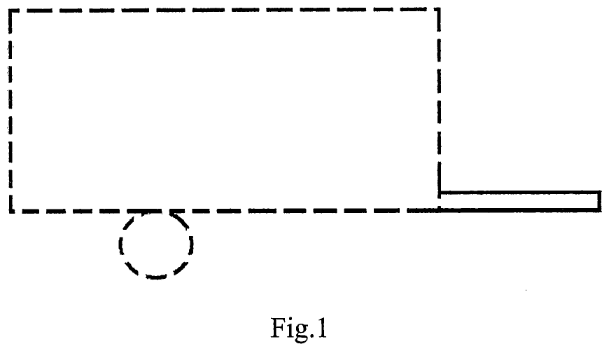

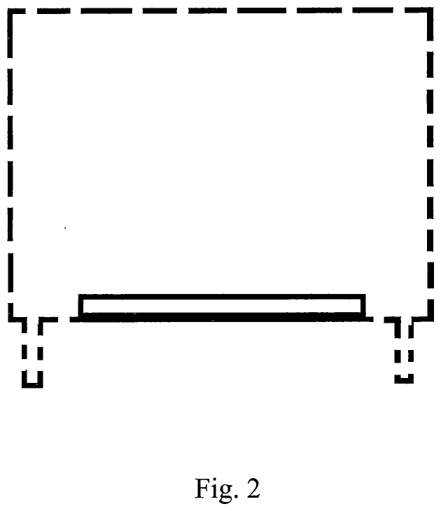

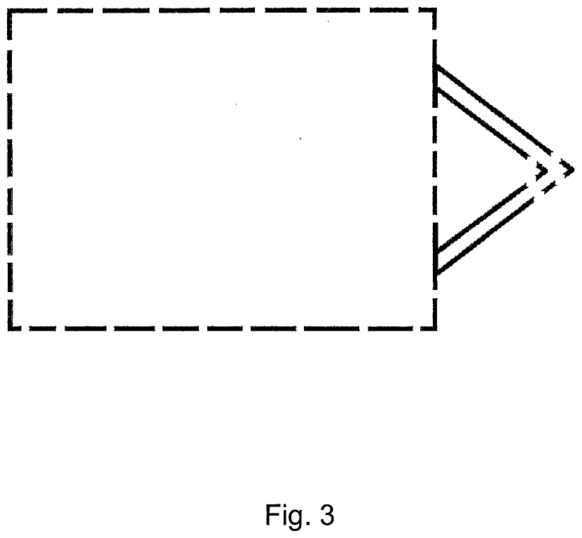

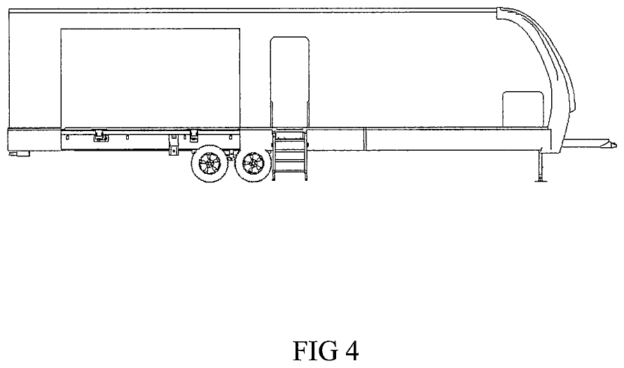

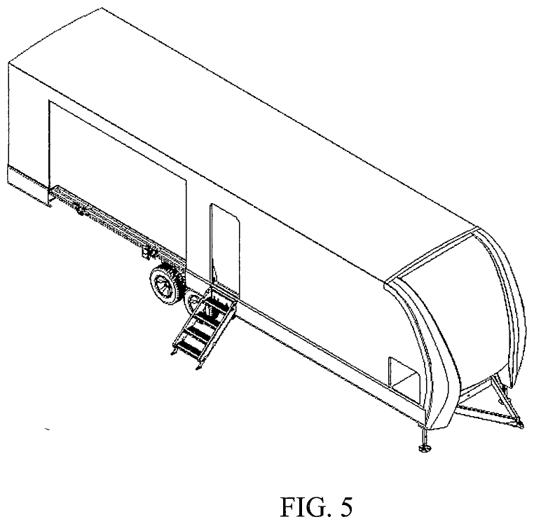

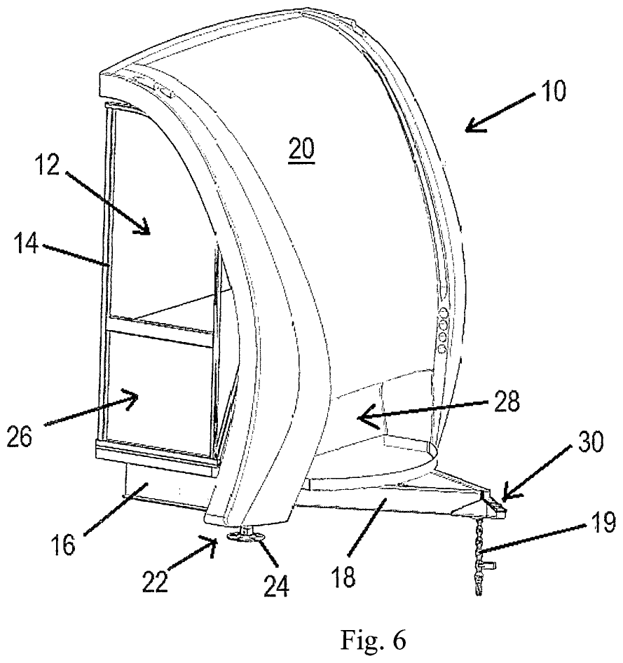

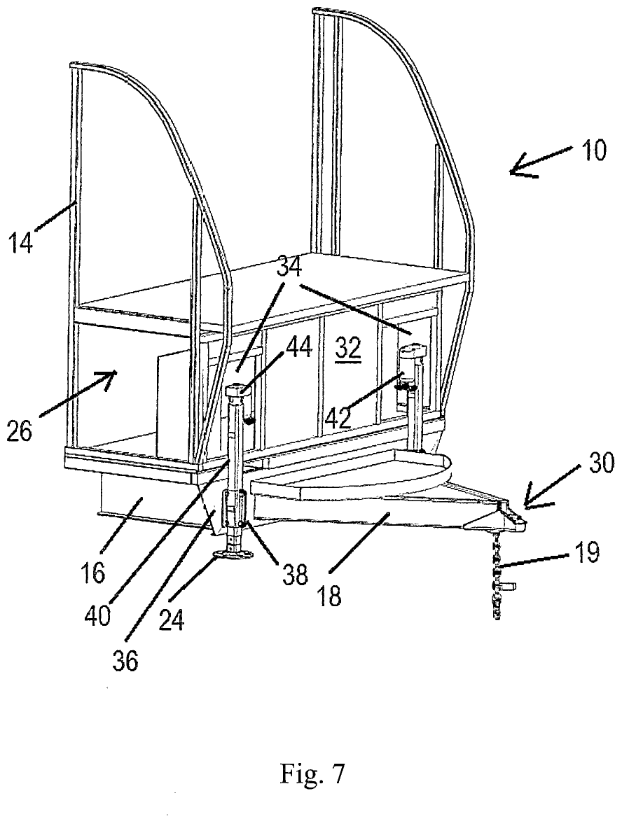

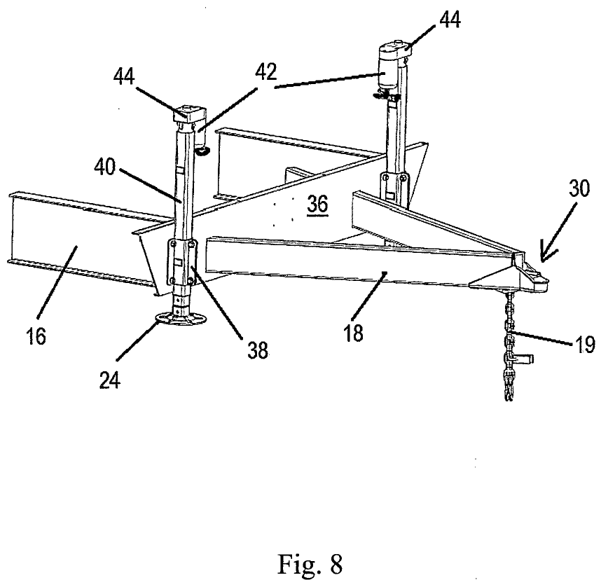

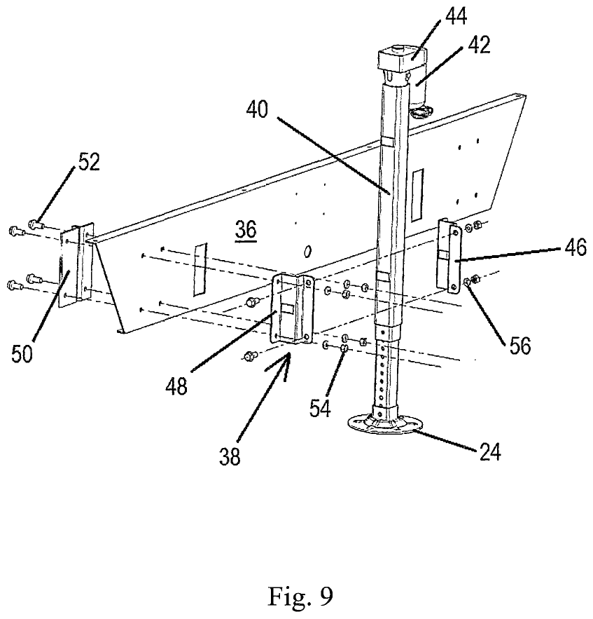

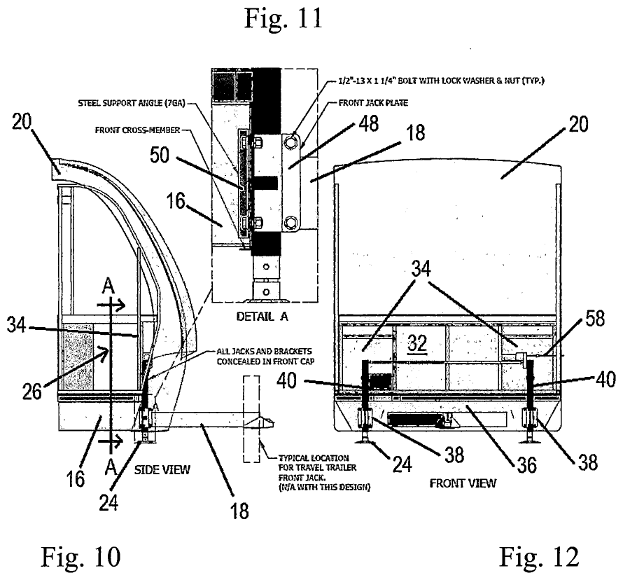

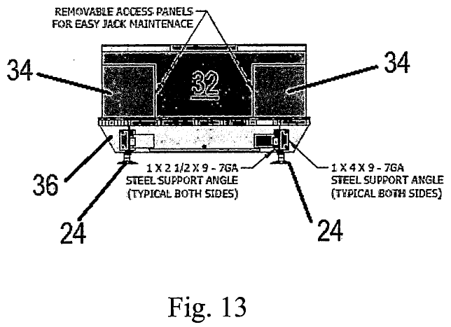

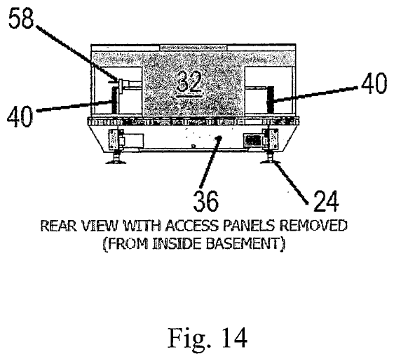

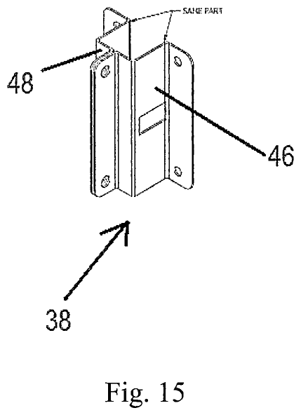

### DETAILED DESCRIPTION OF PREFERRED EMBODIMENTS

The figures show schematically, and in a best mode versions, embodiments of the present invention, as applied to a travel trailer type of RV, both generically and specifically.

The drawings are not to scale from one view to the next.

The following features are illustrated in the drawings by these numerals:

A vehicle 10, preferably a travel trailer type of RV, having:
living quarters 12,
living quarters frame 14,
chassis 16,
hitch tongue 18,
safety chain 19,
front cap 20 (formed, for example, from molded fiberglass or the like), mounted at the front of the living quarters and creating an enclosure between the cap and the living quarters,
landing gear 22 (formed, for example, from otherwise conventional fifth wheel trailer landing gear, as modified herein, having substantially longer telescopic legs than previously used in travel trailers, and preferably electrically or hydraulically actuated with the extra lifting capacity typically previously used only in fifth wheel trailers),
landing gear foot 24,
storage compartment 26 (preferably formed, for example, as a conventional pass-through storage compartment, as modified herein, having exterior side access for travel trailer users and serving as a “basement” or lower storage compartment beneath a portion of the living quarters),
exterior storage area 28, dimensioned, for example, to receive and retain propane tanks, electrical generators, user equipment, and the like,
conventional ball hitch connection 30,
front wall 32 of storage compartment 26,
cap access door 34 opening from within storage compartment 26 to give access to the area between front cap 20 and living quarters frame 14,
chassis front cross member 36,
bracket assembly 38,
landing gear telescopic tubes 40,
landing gear motor 42,
landing gear drive assembly 44,
right Z plate or bracket member 46,
left Z plate or bracket member 48,
backing plate 50,
fastener bolt 52
fastener nut 54,
lock washer 56, and
manual actuator 58.

The landing gear is thus mounted at the forward most point of the travel trailer chassis, providing greater stability against, for example, uneven weight distributions within the travel trailer, movement effects of the users within and exterior wind, as well as more secure support on uneven terrain. Further, bracket assembly 38 is preferably mounted such that the landing extends at a slight angle to the vertical, 1-4 degrees, for example, when it is actuated, so as to provide improved stability, over even certain prior fifth wheel landing gear usage, typically using a vertical mounting. Moreover, angled mounting of the landing gear can avoid potential impact of the moving components of the landing gear with the interior front cap. Further, bracket assembly 38 can reduce vibrational impact of the landing gear with the interior of the front cap when the travel trailer is in transit between use locations or, on occasion, is rocked by user movement within the living quarters or loading and unloading of a toy hauler travel trailer.

Placing the landing gear inside of the front cap also frees up extra storage space in storage compartment 26. At the same time, insignificant portions of the landing gear remain external to the front cap, and do not significantly reduce grand clearance of the travel trailer in motion. Further, placing the landing gear into the front cap area allows the use of landing gear with longer vertical strokes than would otherwise be permitted in certain conventional pass-through storage compartments, without forming those compartments to intrude further into the living quarters. This interior placement of the landing gear also serves to protect the landing gear motor and its drive assembly from the exterior environment. Use of two landing gears 22 on either side of the travel trailer also helps to resist twisting forces which can be applied to the travel trailer in, for example, high wind environments.

Motors 42 can be synchronized in a conventional manner and actuated by conventional remote control devices. Z plates 46 and 48 are preferably removably mounted to cross member 36, and are, for example, formed with a slight gap (on the order of ⅛ inch, for example) between them which permits telescopic legs 40 to be clamped therebetween. Z plates 46 and 48 are also preferably formed with one or more openings which align with conventional detents or projections found on telescopic legs 40, so as to further resist vertical sliding of telescopic legs 40 within bracket assembly 38.

While the present invention has been shown and described herein with respect to certain preferred embodiments and alternative configurations, that were by way of illustration and example only. For example, in FIG. 11, a portion of the landing gear is shown extending slightly below chassis 16 when the landing gear is retracted. In other embodiments, the mounting point of bracket assembly 38 can be raised such that landing gear foot 24 is flush with chassis 16 or retained into the front cap. Also, other telescopic load lifting actuators can be used apart from otherwise conventional fifth wheel-type landing gear, provided they have sufficient extra vertical length and strength capacities for the purposes noted above. Further, various other conventional fasteners can be used to secure the components of bracket assembly 38, as desired in a given application. Accordingly, the spirit and scope of the present invention is intended to be limited only by the terms of the appended claims.

What is claimed is:

1. A travel trailer having:
a chassis,
living quarters mounted on the chassis,
a hitch tongue attached to the chassis for towing the travel trailer, and an
absence of jacks mounted on the hitch tongue.

2. The travel trailer according to claim 1, including:
a cap mounted at the front of the living quarters, creating an enclosure therebetween, and
landing gear mounted between the cap and the living quarters in that enclosure.

3. The travel trailer according to claim 2, wherein:
the chassis includes a front cross member,
the landing gear is secured to the front cross member, and
the landing gear is extendable downward and a slight angle to the vertical to engage the ground and support the travel trailer.

4. The travel trailer according to claim 3 wherein the landing gear is so secured by a pair of opposing Z-shaped bracket members which are removably secured to the front cross member.

5. The travel trailer according to claim 4 wherein the Z-shaped bracket members clamp the landing gear therebetween and are supported on the front cross member by a backing plate on the opposing side of the front cross member.

6. The travel trailer according to claim 5 wherein the Z-shaped bracket members are formed with openings therein which register with projections or detents on the landing gear.

7. The travel trailer according to claim 3, including:
an exteriorly accessible storage compartment rearward of the front cap, and
wherein that compartment includes an access opening to the enclosure between the front cap and the living space frame.

8. The ornamental design for a travel trailer with jackless tongue profile, substantially as shown and described.
